(19) United States
(12) Patent Application Publication
(10) Pub. No.: US 2024/0266086 A1
(43) Pub. Date: Aug. 8, 2024

(54) COMPOSITE CONDUCTIVE PARTICLE AND METHOD FOR MANUFACTURING COMPOSITE CONDUCTIVE PARTICLE

(71) Applicant: DEXERIALS CORPORATION, Shimotsuke-shi, Tochigi (JP)

(72) Inventors: Hidetsugu NAMIKI, Tochigi (JP); Kaori WAKU, Tochigi (JP); Takeshi NISHIO, Tochigi (JP); Yusuke TANAKA, Tochigi (JP); Shoko KUGA, Tochigi (JP)

(73) Assignee: DEXERIALS CORPORATION, Shimotsuke-shi, Tochigi (JP)

(21) Appl. No.: 18/018,796

(22) PCT Filed: Jul. 12, 2021
(86) PCT No.: PCT/JP2021/026175

§ 371 Date: Jan. 30, 2023

(30) Foreign Application Priority Data
Jul. 30, 2020 (JP) 2020-129750

(51) Int. Cl. H01B 1/22; B23K 35/02; B23K 35/30; B23K 35/36

(52) U.S. Cl. CPC H01B 1/22; B23K 35/0244; B23K 35/3613; B23K 35/302; B23K 35/3033

(57) ABSTRACT

A composite conductive particles capable of suppressing cracking and peeling of metal films to provide excellent adhesion of metal films, and a method for manufacturing a composite conductive particle. The composite conductive particle includes a host particle; and adhesive fine particles arranged on a surface of the host particle and containing oxygen atoms; and conductive fine particles in contact with the adhesive fine particle. By arranging adhesive fine particles containing oxygen atoms on the surface of the host particle and bringing the conductive fine particles into contact with the adhesive fine particles, it is possible to achieve excellent adhesion of the metal film.

### TECHNICAL FIELD

The present technology relates to a composite conductive particle in which a metal film is formed on a particle surface and a method for manufacturing a composite conductive particle. This application claims priority based on Japanese Patent Application No. 2020-129750 filed on Jul. 30, 2020, in Japan, which is incorporated by reference in this application.

### BACKGROUND ART

A technique is known in which small particles are made to physically collide with a surface of a host particle by a mechanochemical method to form a film with the small particles on the surfaces of the host particle (see, e.g., Patent Document 1).

FIG. 6 is a cross-sectional view for explaining a coated conductive particle in which a metal film is formed on the surface of the host particle by the conventional method, and FIG. 7 is a cross-sectional view for explaining the metal film when the conventional coated conductive particle is pressurized. As shown in FIG. 6, when a metal film 104 is to be formed on the surface of the host particle 101 by the conventional method, it is sometimes difficult to form the metal film 104 depending on the type of metal particles 103. In addition, even if the metal film 104 could be formed, the metal film 104 was sometimes brittle. Also, as shown in FIG. 7, when the coated conductive particle is sandwiched between metal terminals 110 and 120, the metal film 104 sometimes cracked or peeled off from the host particle 101.

### CITATION LIST

### Patent Literature

Patent Document 1: Japanese Unexamined Patent Application Publication No. 2005-209491

### SUMMARY OF INVENTION

### Technical Problem

The present technology was proposed in view of such conventional circumstances, and provides a composite conductive particle that is able to suppress cracking and peeling of metal films to provide excellent adhesion of metal films, and a method for manufacturing a composite conductive particle.

### Solution to Problem

A composite conductive particle according to the present technology includes: a host particle; and an adhesive fine particle arranged on a surface of the host particle and containing oxygen atoms; and a conductive fine particle in contact with the adhesive fine particle.

A method for manufacturing a composite conductive particle according to the present technology includes: mixing host particles, adhesive fine particles containing oxygen atoms, and conductive fine particles by a mechanochemical method; arranging the adhesive fine particles on the surface of the host particles; and bringing the conductive fine particles into contact with the adhesive fine particles.

A method for manufacturing a composite conductive particle according to the present technology includes: mixing host particles and adhesive fine particles containing oxygen atoms by a mechanochemical method; subsequently mixing conductive fine particles by a mechanochemical method; arranging the adhesive fine particles on the surface of the host particles; and bringing the conductive fine particles into contact with the adhesive fine particles.

### Advantageous Effects of Invention

The present technology arranges the adhesive fine particles containing oxygen atoms on the surface of the host particle and brings the conductive fine particles into contact with the adhesive fine particles, thereby achieving excellent adhesion of the metal film.

### BRIEF DESCRIPTION OF DRAWINGS

FIG. 1 is a cross-sectional view illustrating a first composite conductive particle according to the present technology.

FIG. 2 is a cross-sectional view illustrating a second composite conductive particle according to the present technology.

FIG. 3 is a cross-sectional view for explaining a mixing step in a method for manufacturing a composite conductive particle according to a first embodiment.

FIG. 4 is a cross-sectional view for explaining a first mixing step in a method for manufacturing a composite conductive particle according to a second embodiment.

FIG. 5 is a cross-sectional view for explaining a second mixing step in the method for manufacturing a composite conductive particle according to a second embodiment.

FIG. 6 is a cross-sectional view for explaining a coated conductive particle in which a metal film is formed on a surface of a host particle by a conventional method.

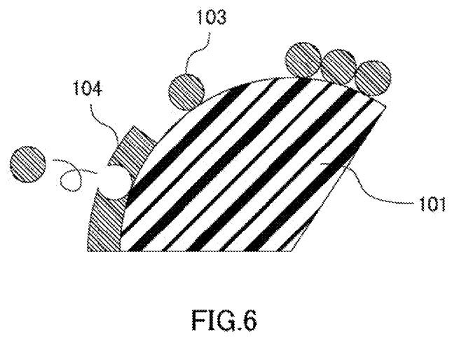

FIG. 7 is a cross-sectional view for explaining the metal film when the conventional coated conductive particle is pressurized.

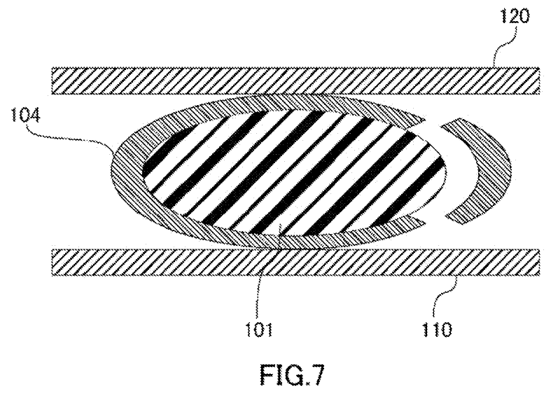

### DESCRIPTION OF EMBODIMENTS

Embodiments of the present invention will be described in detail in the following order with reference to the drawings.
1. COMPOSITE CONDUCTIVE PARTICLE
2. METHOD FOR MANUFACTURING A COMPOSITE CONDUCTIVE PARTICLE
3. EXAMPLES

### 1. Composite Conductive Particle

The composite conductive particle according to the present embodiment includes a host particle, an adhesive fine particle arranged on the surface of the host particle and containing oxygen atoms, and a conductive fine particle in contact with the adhesive fine particle. By arranging the adhesive fine particle containing oxygen atoms on the surface of the host particle and bringing the conductive fine particle into contact with the adhesive fine particle, it is possible to achieve excellent adhesion of the metal film.

Here, “the state in which the adhesive fine particle is arranged on the surface of the host particle” includes at least the state in which the adhesive fine particle is in direct contact with the surface of the host particle. In addition, “the state in which the conductive fine particle is in contact with the adhesive fine particle” includes at least the state in which the conductive fine particle is in direct contact with the adhesive fine particle. Such a state can be confirmed, e.g., by observing cross sections of the composite conductive particle by using a field-emission scanning electron microscope (FE-TEM/EDS).

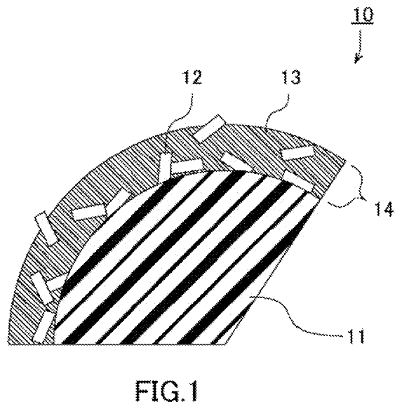

FIG. 1 is a cross-sectional view illustrating a first composite conductive particle according to the present technology. The first composite conductive particle 10 includes: a host particle 11; adhesive fine particles 12 arranged on a surface of the host particle 11 and contain oxygen atoms; and conductive fine particles 13 in contact with the adhesive fine particles 12, a mixture of the adhesive fine particles 12 and the conductive fine particles 13 forming a composite conductive layer 14 on the surface of the host particle 11.

Examples of the host particle 11 may include a resin particle, resin core conductive particle, organic-inorganic hybrid particle, and metal particle. Examples of resins constituting the resin particle include styrene-divinylbenzene copolymers, benzoguanamine resins, cross-linked polystyrene resins, acrylic resins, and styrene-silica composite resins. The resin core conductive particles are those in which a metal plating layer is provided on the surface of the aforementioned resin particles, and the metal plating layer is preferably a single metal or alloy of at least one of nickel, silver, copper, gold, and palladium. The thickness of the metal plating layer is preferably 50 to 300 nm, more preferably 80 to 250 nm. When the metal plating layer is composed of multiple metal layers, it is preferable that the total thickness satisfies the above range. The organic-inorganic hybrid particles include, e.g., particles formed by crosslinked alkoxysilyl polymers and acrylic resins. Examples of metal particles include nickel, cobalt, silver, copper, gold, palladium, and solder. Among these, it is preferable to use resin particles or resin core conductive particles having excellent stress relaxation properties.

The average particle size of the host particle 11 is preferably 3 to 300 μm, more preferably 10 to 50 μm. With this range, a good metal film can be formed by using a mechanochemical method. The particle size of the conductive particles may be measured by an image type particle size distribution meter (for example, FPIA-3000: manufactured by Malvern). The number of the particles is 1,000 or more, preferably 2,000 or more.

Examples of the adhesive fine particles 12 include organic polymer particles having oxygen atoms, organic fine particles containing organic monomer particles, and inorganic fine particles. Organic fine particles are not particularly limited as long as they have oxygen atoms and may include, e.g., (meth) acrylate compounds and epoxy compounds. Here, the (meth) acrylate compound includes an acrylate and a methacrylate and may be a polymer or a monomer. Epoxy compounds may include prepolymers and resins formed by curing the prepolymers.

In addition, resin particles having carboxyl groups are preferably used to impart a flux function to the composite conductive particles 10. Examples of resin particles having carboxyl groups include bisphenol AO,O-diacetic acid. This can remove oxide film and dirt from the surface of the electrode. In addition, when using solder fine particles such as SnBi and SnAgCu are used as conductive fine particles 13, not only the oxide film and dirt on the electrode surface mentioned above but also the oxide film and dirt on the melted solder surface can be removed.

The average particle size of the adhesive fine particles 12 is preferably 1/10 to 1/100,000 of the average particle size of the host particles 11, and more preferably 1/100 to 1/10,000. Thus, a metal film can be formed by the conductive fine particles 13.

The conductive fine particles 13 include single-composition metal particles such as Au, Ag, Cu, and Ni, as well as composite metal particles such as SnBi and SnAgCu. The present technology, using adhesive fine particles having oxygen atoms, can thicken the metal film not only with soft metals such as SnBi and SnAgCu but also with hard metals such as Cu and Ni, which have been difficult to be thickened in conventional methods.

As with the adhesive fine particles 12, the average particle size of the conductive fine particles 13 is preferably 1/10 to 1/100,000 of the average particle size of the host particles 11, and more preferably 1/100 to 1/10,000. Thus, a metal film can be formed by the conductive fine particles 13.

The composite conductive layer 14, which is a metal film arranged on the surface of the host particle 11, is formed by a mixture of adhesive fine particles 12 containing oxygen atoms and conductive fine particles 13 contacting the adhesive fine particles 12. In addition, the composite conductive layer 14 also includes a part where the adhesive fine particles 12 directly contact the surface of the host particle 11 and a part where the conductive fine particles 13 directly contact the surface of the host particle 11. In other words, in the composite conductive layer 14, the adhesive fine particles 12 cover a part of the surface of the host particle 11. This can achieve excellent adhesion of the composite conductive layer 14.

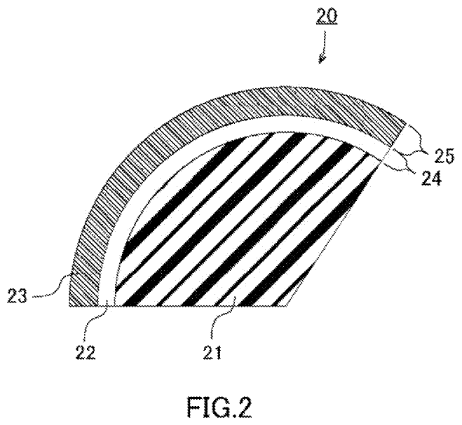

FIG. 2 is a cross-sectional view illustrating a second composite conductive particle according to the present technology. The second composite conductive particle 20 includes: a host particle 21; adhesive fine particles 22 arranged on the surface of the host particle 21 and containing oxygen atoms; and conductive fine particles 23 in contact with the adhesive fine particles 22. In the second composite conductive particle 20, an adhesive layer 24 composed of the adhesive fine particles 22 is formed on the surface of the host particle 21, and a conductive layer 25 composed of the conductive fine particles 23 is formed on the adhesive layer 24. Since the host particle 21, the adhesive fine particle 22, and the conductive fine particle 23 of the second composite conductive particle 20 are the same as the host particle 11, the adhesive fine particle 12, and the conductive fine particle 13 of the first composite conductive particle 10, respectively, the explanation thereof is omitted here.

The adhesive layer 24 is formed from adhesive fine particles 22, and the adhesive fine particles 12 are in direct contact with almost all of the surfaces of the host particle 11. That is, in the adhesive layer 24, the adhesive fine particles 22 cover almost the entire surface of the host particle 21.

The conductive layer 25 is a metal film formed from conductive fine particles 23, and the conductive fine particles 23 are in direct contact with almost the entire surface of the adhesive layer 24. Since the adhesive fine particles 22 cover almost the entire surface of the host particle 21, superior adhesion of the conductive layer 25 can be obtained compared with the conventional conductive particles lacking the adhesive layer 24.

### 2. Method for Manufacturing a Composite Conductive Particle

A method for manufacturing a composite conductive particle according to a first embodiment includes mixing host particles, adhesive fine particles containing oxygen atoms, and a conductive fine particles by a mechanochemical method, arranging the adhesive fine particles on the surface of the host particles, and bringing the conductive fine particle into contact with the adhesive fine particles. This can achieve excellent adhesion of the metal film.

Here, the mechanochemical method is a method that utilizes chemical reactions generated by mechanical energy applied to a substance in mechanical operations such as collision, compression, grinding, mixing, and kneading; examples of the mechanochemical method may include mixing methods using a high-speed agitation type powder spheroidizing device or a hybridizer, among others.

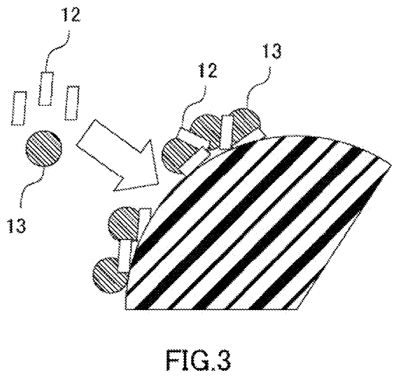

FIG. 3 is a cross-sectional view for explaining the mixing step in the method for manufacturing a composite conductive particle according to the first embodiment. The same parts as those of the first composite conductive particle 10 are denoted by the same reference numerals, and the explanation thereof is omitted.

As shown in FIG. 3, in the mixing step, the host particles 11, the adhesive fine particles 12, and the conductive fine particles 13 are mixed by a mechanochemical method, so that the adhesive fine particle 12 and the conductive fine particle 13 are made to collided with the host particle 11 to form a composite conductive layer 14, which is a metal film.

The blending ratio of the adhesive fine particles 12 to the conductive fine particles 13 (mass of adhesive fine particles:mass of conductive fine particles) is preferably 0.001:1 to 0.3:1, more preferably 0.01:1 to 0.2:1, and still more preferably 0.05:1 to 0.15:1. Thus, as shown in FIG. 1, it is possible to form the composite conductive layer 14 including a part where the adhesive fine particles 12 directly contact the surface of the host particle 11 and a part where the conductive fine particles 13 directly contact the surface of the host particle 11, thereby achieving excellent adhesion of the composite conductive layer 14.

Furthermore, a method for manufacturing the composite conductive particles according to the second embodiment includes mixing host particles and adhesive fine particles containing oxygen atoms by a mechanochemical method, subsequently mixing conductive fine particles by a mechanochemical method, arranging the adhesive fine particles on the surface of the host particles, and bringing the conductive fine particles into contact with the adhesive fine particles. This can achieve excellent adhesion of the metal film.

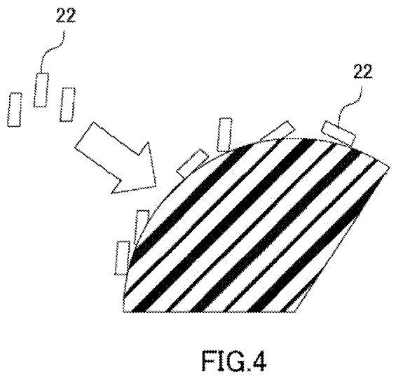

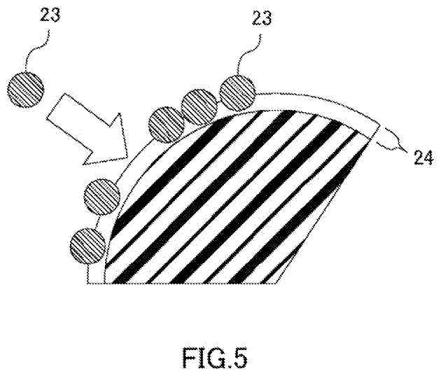

FIG. 4 is a cross-sectional view for explaining the first mixing step in the method for manufacturing a composite conductive particle according to the second embodiment, and FIG. 5 is a cross-sectional view for explaining the second mixing step in the method for manufacturing a composite conductive particle according to the second embodiment. The same parts as those of the second composite conductive particle 20 are denoted by the same reference numerals, and the explanation thereof is omitted.

As shown in FIG. 4, in the first mixing step, the host particles 21 and the adhesive fine particles 22 are mixed by a mechanochemical method, and the adhesive fine particles 22 are made to collide with the host particle 21 to form the adhesive layer 24. Then, as shown in FIG. 5, in the second mixing step, after forming the adhesive layer 24, the conductive fine particles 23 are mixed by a mechanochemical method, and the conductive fine particles 23 are made to collided with the adhesive layer 24 to form the conductive layer 25.

Here, the blending ratio of the adhesive fine particles 22 to the conductive fine particles 23 (mass of the adhesive fine particles:mass of the conductive fine particles) is preferably 0.001:1 to 0.3:1, more preferably 0.01:1 to 0.2:1, and still more preferably 0.05:1 to 0.15:1 as with the method for manufacturing a composite conductive particle according to the first embodiment. Thus, as shown in FIG. 2, the adhesive layer 24 composed of adhesive fine particles 22 can be formed on the surface of the host particle 21, and the conductive layer 25 composed of conductive fine particles 23 can be formed on the adhesive layer 24, thereby achieving excellent adhesion of the conductive layer 25.

### EXAMPLES

Examples of the present technology will be described below. In the examples, composite conductive particles with a metal film formed on the surface of the particles were prepared by a mechanochemical method. Then, connection structures were fabricated by using the conductive films containing composite conductive particles, and the conduction characteristics thereof were evaluated. It should be noted that the present technology is not limited to these examples.

### Preparation of Conductive Film

A conductive adhesive composition was prepared by introducing 5 parts by mass of a mixture containing composite conductive particles and 95 parts by mass of an insulating binder composed of the following components into a planetary agitator and stirring them for 1 minute. Then, the conductive adhesive composition was applied on a PET film, dried in an oven at 80° C. for 5 minutes to form an adhesive layer composed of the conductive adhesive composition on the PET film, thereby preparing a conductive film having a width of 2.0 mm and a thickness of 25 μm.

The insulating binder was prepared by mixing 47 parts by mass of phenoxy resin (product name: YP-50, manufactured by NSCC Epoxy Manufacturing), 3 parts by mass of monofunctional monomer (product name: M-5300, manufactured by TOAGOSEI), 25 parts by mass of urethane resin (product name: UR-1400, manufactured by Toyobo), 15 parts by mass of rubber component (product name: SG80H, manufactured by Nagase ChemteX), 2 parts by mass of silane coupling agent (product name: A-187, manufactured by Momentive Performance Materials Japan), and 3 parts by mass of organic peroxide (product name: NiperBW, manufactured by Nichiyu Corporation), into a mixed solution of ethyl acetate and toluene so that the solid content was 50% by mass.

### Preparation of Connection Structure

A connection structure was prepared by thermocompression-bonding, via an anisotropic conductive film, an evaluation substrate (glass epoxy substrate (FR4), 200 μm pitch, line:space=1:1, terminal thickness 10 μm, Cu (undercoat)/Ni/Au plating) and an FPC (polyimide film, 200 μm pitch, line:space=1:1, terminal thickness 12 μm, Cu (undercoat)/Ni/Au plating). Thermo-compression bonding was carried out by pressing down the tool from the FPC side through a silicone rubber having a thickness of 200 μm under the conditions of a temperature of 150° C., a pressure of 2 MPa, and a time of 20 second.

### Evaluation of Conduction Property

The conduction resistance value of the connection structure was measured with four-terminal sensing using a digital multimeter (manufactured by Yokogawa Electric Corporation) by flowing a current of 1 mA. In addition, after an environmental test at a temperature of 85° C., a humidity of 85%, and a duration of 500 hours, the conduction resistance values of the connected structures were measured. The connection structures in which the conduction resistance value was 500 mΩ or less were evaluated as “AA”, the connection structures in which the conduction resistance value is more than 500 mΩ and 102 or less were evaluated as “A”, the connection structures in which the conduction resistance value is more than 102 were evaluated as “B”, and the connection structures in which the conduction resistance value was OPEN were evaluated as “C”.

### Evaluation of Metal Film

Cracking and peeling of the metal film was evaluated by performing cross-sectional observation of composite conductive particles in the terminal part of the connection structure. Those in which there were no cracks in the metal film of the composite conductive particles in the terminal part were evaluated as “A”, those in which there were cracks in the metal film in less than half of the composite conductive particles in the terminal part were evaluated as “B”, and those in which there were cracks in the metal film in half or more of the composite conductive particles in the terminal part were evaluated as “C”.

In addition, those in which there were no peeling off of the metal film of the composite conductive particles in the terminal part were evaluated as “A”, those in which there were peeling off of the metal film in less than half of the composite conductive particles in the terminal part were evaluated as “B”, and those in which there were peeling off of the metal film in half or more of the composite conductive particles in the terminal part were evaluated as “C”.

### Example 1

Acrylic resin core Ni-plated particles (20 μm in diameter), Cu particles (100 nm in diameter), and MMA (methyl methacrylate, approximately 100 nm in diameter) were prepared as host particles, conductive fine particles, and adhesive fine particles, respectively.

After measuring 8 parts by mass of adhesive fine particles with respect to 100 parts by mass of conductive fine particles, the host particles, conductive fine particles, and adhesive fine particles were placed in a cup and mixed with a wood bar for 1 minute. This was fed into a high-speed agitation type powder spheroidizer (NSM-200, SEISHIN ENTERPRISE), and the granulation was carried out at 3,000 rpm for 1 min under nitrogen atmosphere to produce composite conductive particles.

The evaluation results of the connection structure prepared by using the conductive film containing composite conductive particles in Example 1 are shown in Table 1. The initial conductivity was evaluated as “AA” and the conduction reliability after the environmental test was evaluated as “A”. Also, the cracking of the metal film of the composite conductive particles in the terminal part of the connection structure was evaluated as “A”, and the peeling of the metal film of the composite conductive particles in the terminal part of the connection structure was evaluated as “A”.

### Example 2

Composite conductive particles were prepared in the same manner as in Example 1, except that acrylic resin core Ni-plated particles (20 μm in diameter), Ni particles (100 nm in diameter), and MMA (methyl methacrylate, approximately 100 nm in diameter) were prepared as host particles, conductive fine particles, and adhesive fine particles, respectively.

The evaluation results of the connection structure prepared by using the conductive film containing composite conductive particles in Example 2 are shown in Table 1. The initial conductivity was evaluated as “AA” and the conduction reliability after the environmental test was evaluated as “A”. Also, the cracking of the metal film of the composite conductive particles in the terminal part of the connection structure was evaluated as “A”, and the peeling of the metal film of the composite conductive particles in the terminal part of the connection structure was evaluated as “A”.

### Example 3

Composite conductive particles were prepared in the same manner as in Example 1, except that acrylic resin core Ni-plated particles (20 μm in diameter), Cu particles (100 nm in diameter), and bisphenol AO,O-diacetic acid (approximately 100 nm in diameter) were prepared as host particles, conductive fine particles, and adhesive fine particles, respectively.

The evaluation results of the connection structure prepared by using the conductive film containing composite conductive particles in Example 3 are shown in Table 1. The initial conductivity was evaluated as “AA” and the conduction reliability after the environmental test was evaluated as “A”. Also, the cracking of the metal film of the composite conductive particles in the terminal part of the connection structure was evaluated as “A”, and the peeling of the metal film of the composite conductive particles in the terminal part of the connection structure was evaluated as “A”.

### Example 4

Composite conductive particles were prepared in the same manner as in Example 1, except that acrylic resin core Ni-plated particles (20 μm in diameter), Cu particles (100 nm in diameter), and silica (SiO₂, approximately 100 nm in diameter) were prepared as host particles, conductive fine particles, and adhesive fine particles, respectively.

The evaluation results of the connection structure prepared by using the conductive film containing composite conductive particles in Example 4 are shown in Table 1. The initial conductivity was evaluated as “AA” and the conduction reliability after the environmental test was evaluated as “A”. Also, the cracking of the metal film of the composite conductive particles in the terminal part of the connection structure was evaluated as “A”, and the peeling of the metal film of the composite conductive particles in the terminal part of the connection structure was evaluated as “A”.

### Example 5

Composite conductive particles were prepared in the same manner as in Example 1, except that acrylic resin particles (20 μm in diameter), Cu particles (100 nm in diameter), and MMA (methyl methacrylate, approximately 100 nm in diameter) were prepared as host particles, conductive fine particles, and adhesive fine particles, respectively.

The evaluation results of the connection structure prepared by using the conductive film containing composite conductive particles in Example 5 are shown in Table 1. The initial conductivity was evaluated as “AA” and the conduction reliability after the environmental test was evaluated as “A”. Also, the cracking of the metal film of the composite conductive particles in the terminal part of the connection structure was evaluated as “A”, and the peeling of the metal film of the composite conductive particles in the terminal part of the connection structure was evaluated as “A”.

### Example 6

Acrylic resin particles (20 μm in diameter), Cu particles (100 nm in diameter), and MMA (methyl methacrylate, approximately 100 nm in diameter) were prepared as host particles, conductive fine particles, and adhesive fine particles, respectively.

After measuring 11 parts by mass of adhesive fine particles with respect to 100 parts by mass of conductive fine particles, the host particles and adhesive fine particles were placed in a cup and mixed with a wood bar for 1 minute. This was fed into a high-speed agitation type powder spheroidizer (NSM-200, SEISHIN ENTERPRISE), and the granulation was carried out at 3,000 rpm for 1 min under nitrogen atmosphere.

The granulated particles and conductive fine particles were then placed in a cup and mixed with a wood bar for 1 minute. This was fed into a high-speed agitation type powder spheroidizer (NSM-200, SEISHIN ENTERPRISE), and the granulation was carried out at 3,000 rpm for 1 min under nitrogen atmosphere to produce composite conductive particles.

The evaluation results of the connection structure prepared by using the conductive film containing composite conductive particles of Example 6 are shown in Table 1. The initial conductivity was evaluated as “AA” and the conduction reliability after the environmental test was evaluated as “A”. Also, the cracking of the metal film of the composite conductive particles in the terminal part of the connection structure was evaluated as “B” and the peeling of the metal film of the composite conductive particles in the terminal part of the connection structure was evaluated as “A”.

### Example 7

Composite conductive particles were prepared in the same manner as in Example 1, except that acrylic resin core Ni-plated particles (20 μm in diameter), SnBi particles (100 nm in diameter), and bisphenol AO,O-diacetic acid (approximately 100 nm in diameter) were prepared as host particles, conductive fine particles, and adhesive fine particles, respectively.

The evaluation results of the connection structure prepared by using the conductive film containing the composite conductive particles of Example 7 are shown in Table 1. The initial conductivity was evaluated as “AA” and the conduction reliability after the environmental test was evaluated as “AA”. Also, the cracking of the metal film of the composite conductive particles in the terminal part of the connection structure was evaluated as “A”, and the peeling of the metal film of the composite conductive particles in the terminal part of the connection structure was evaluated as “A”.

### Comparative Example 1

Acrylic resin core Ni-plated particles (20 μm in diameter) and Cu particles (100 nm in diameter) were prepared as host particles and conductive particles, respectively.

The host particle and conductive fine particles were placed in a cup and mixed with a wood bar for 1 minute. This was fed into a high-speed agitation type powder spheroidizer (NSM-200, SEISHIN ENTERPRISE), and the granulation was carried out at 3,000 rpm for 1 min under nitrogen atmosphere to produce composite conductive particles.

The evaluation results of the connection structure prepared by using the conductive film containing the composite conductive particles of Comparative Example 1 are shown in Table 1. The initial conductivity was evaluated as “AA” and the conduction reliability after the environmental test was evaluated as “B”. Also, the cracking of the metal film of the composite conductive particles in the terminal part of the connection structure was evaluated as “C”, and the peeling of the metal film of the composite conductive particles in the terminal part of the connection structure was evaluated as “C”.

### Reference Example 1

Composite conductive particles were prepared in the same manner as in Comparative Example 1, except that acrylic resin core Ni-plated particles (20 μm in diameter) and SnBi particles (100 nm in diameter) were prepared as host particles and conductive fine particles, respectively.

The evaluation results of the connection structure prepared by using the conductive film containing composite conductive particles in Reference Example 1 are shown in Table 1. The initial conductivity was evaluated as “AA” and the conduction reliability after the environmental test was evaluated as “A”. Also, the cracking of the metal film of the composite conductive particles in the terminal part of the connection structure was evaluated as “A”, and the peeling of the metal film of the composite conductive particles in the terminal part of the connection structure was evaluated as “A”.

TABLE 1

| | | | Ex. 1 | Ex. 2 | Ex. 3 | Ex. 4 | Ex. 5 |
|---|---|---|---|---|---|---|---|
| ingredients | A: host particle | material | Ni-plated | Ni-plated | Ni-plated | Ni-plated | resin partilce |
| | | average | resin particle | resin particle | resin particle | resin particle | 20 |
| | | particle | 20 | 20 | 20 | 20 | |
| | | size(um) | | | | | |
| | B: conductive | material | Cu nano-particle | Ni nano-particle | Cu nano-particle | Cu nano-particle | Cu nano-particle |
| | fine particle | average | 100 nm | 100 nm | 100 nm | 100 nm | 100 nm |
| | | particle | | | | | |
| | | size(nm) | | | | | |
| | C: adhesive | material | MMA | MMA | bisphenol AO,O- | SiO2 | MMA |
| | fine particle | average | 100 nm | 100 nm | diacetic acid | 100 nm | 100 nm |
| | | particle | | | 1000 nm | | |
| | | size(nm) | | | | | |

| blending ratio B:C (mass ratio) | | 1:0.08 | 1:0.08 | 1:0.08 | 1:0.08 | 1:0.08 |
|---|---|---|---|---|---|---|
| film formation | process | A + B + C | A + B + C | A + B + C | A + B +C | A + B + C |
| | mechanochemical conditions | 3000 rpm-1 min | 3000 rpm-1 min | 3000 rpm-1 min | 3000 rpm-1 min | 3000 rpm-1 min |
| evaluation | initial conductivity | AA | AA | AA | AA | AA |
| | conduction reliability | A | A | A | A | A |
| | cracking of metal film | A | A | A | A | A |
| | peeling of metal film | A | A | A | A | A |

| | | | Ex. 6 | Ex. 7 | Comp. 1 | Ref. 1 |
|---|---|---|---|---|---|---|
| ingredients | A: host particle | material | resin partilce | Ni-plated | Ni-plated | Ni-plated |
| | | average | 20 | resin particle | resin particle | resin particle |
| | | particle | | 20 | 20 | 20 |
| | | size(um) | | | | |
| | B: conductive | material | Cu nano-particle | SnBi nano-particle | Cu nano-particle | SnBi nano-particle |
| | fine particle | average | 100 nm | 100 nm | 100 nm | 100 nm |
| | | particle | | | | |
| | | size(nm) | | | | |
| | C: adhesive | material | MMA | bisphenol AO,O- | — | — |
| | fine particle | average | 100 nm | diacetic acid | — | — |
| | | particle | | 1000 nm | | |
| | | size(nm) | | | | |

| blending ratio B:C (mass ratio) | | 1:0.11 | 1:0.08 | — | — |
|---|---|---|---|---|---|
| film formation | process | A + C → B | A + B + C | A + B | A + B |
| | mechanochemical conditions | 3000 rpm-1 min | 3000 rpm-1 min | 3000 rpm-1 min | 3000 rpm-1 min |
| | | respectively | | | |
| evaluation | initial conductivity | AA | AA | AA | AA |
| | conduction reliability | A | AA | B | A |
| | cracking of metal film | B | A | C | A |
| | peeling of metal film | A | A | C | A |

When a metal film of high-hardness metal was formed directly on the surface of the host particle, as in Comparative Example 1, cracking and peeling of the metal film occurred, which degraded the evaluation of conduction reliability after the environmental test. In contrast, when adhesive fine particles containing oxygen atoms were placed on the surface of the host particles and a metal film containing conductive fine particles in contact with the adhesive fine particles was formed as in Examples 1 to 7, the cracking and peeling of the metal film were suppressed, even for metals with high hardness, which improved the conduction reliability after the environmental test. In particular, it was found that excellent adhesion of the metal film can be obtained by forming a metal film with a part where the adhesive fine particles directly contact the surface of the host particle and a part where the conductive fine particles directly contact the surface of the host particle.

### REFERENCE SIGNS LIST

10 first composite conductive particle, 11 host particle, 12 adhesive fine particle, 13 conductive fine particle, 14 composite conductive layer, 20 second composite conductive particle, 21 host particle, 22 adhesive fine particle, 23 conductive fine particle, 24 adhesive layer, 25 conductive layer, 101 host particle, 103 metal particle, 104 metal film, 110, 120 metal terminal

1. A composite conductive particle, comprising:
a host particle; and
an adhesive fine particle arranged on a surface of the host particle and containing oxygen atoms; and
a conductive fine particle in contact with the adhesive fine particle.

2. The composite conductive particle according to claim 1, wherein
the adhesive fine particle is an organic fine particle or an inorganic fine particle, and
the conductive fine particle is a single-composition metal particle or a composite metal particle.

3. The composite conductive particle according to claim 2, wherein the adhesive fine particle and the conductive fine particle have an average particle size of 1/10 to 1/100,000 of the average particle size of the host particle.

4. The composite conductive particle according to claim 1, wherein the adhesive fine particle is a resin particle having a carboxyl group.

5. The composite conductive particle according to claim 1, wherein the conductive fine particle contains Cu or Ni.

6. The composite conductive particle according to claim 1, wherein the conductive fine particle is a solder particle.

7. The composite conductive particle according to claim 1, wherein the adhesive fine particle is one or more selected from methyl methacrylate, bisphenol AO,O-diacetic acid, or silica.

8. A method for manufacturing a composite conductive particle, the method comprising: mixing host particles, adhesive fine particles containing oxygen atoms, and conductive fine particles by a mechanochemical method; arranging the adhesive fine particles on the surface of the host particles; and bringing the conductive fine particles into contact with the adhesive fine particles.

9. A method for manufacturing composite conductive particle, the method comprising: mixing host particles and adhesive fine particles containing oxygen atoms by a mechanochemical method; subsequently mixing conductive fine particles by a mechanochemical method; arranging the adhesive fine particles on the surface of the host particles; and bringing the conductive fine particles into contact with the adhesive fine particles.

10. The method for manufacturing a composite conductive particle according to claim 8, wherein the blending ratio of the adhesive fine particles to the conductive fine particles (mass of the adhesive fine particles:mass of the conductive fine particles) is 0.001:1 to 0.3:1.

11. The composite conductive particle according to claim 4, wherein the conductive fine particle contains Cu or Ni.

12. The composite conductive particle according to claim 4, wherein the conductive fine particle is a solder particle.

13. The composite conductive particle according to claim 4, wherein the adhesive fine particle is one or more selected from methyl methacrylate, bisphenol AO,O-diacetic acid, or silica.
